(19) United States
(12) Patent Application Publication
(10) Pub. No.: US 2009/0278454 A1
(43) Pub. Date: Nov. 12, 2009

(54) OLED DISPLAY ENCAPSULATED WITH A FILTER

(76) Inventors: Elena A. Fedorovskaya, Pittsford, NY (US); John A. Agostinelli, Rochester, NY (US); Ronald S. Cok, Rochester, NY (US)

Correspondence Address: Amelia A. Buharin;Patent Legal Staff, Eastman Kodak Company, 343 State Street, Rochester, NY, 14650-2201, US

(21) Appl. No.: 12/118,880

(22) Filed: May 12, 2008

(51) Int. Cl. H01J 1/62

(52) U.S. Cl. 313/512

(57) ABSTRACT

The invention is directed towards an encapsulated electronic device, comprising a substrate; an electronic device on a first surface of the substrate; a first thin-film layer of a first inorganic material having a first optical property on the thin-film electronic device; and a second thin-film layer of a second inorganic material having a second optical property which is different from the first optical property on the first thin-film layer and wherein at least one of the first layer or the second layer is also an encapsulation layer and wherein the first thin-film layer and the second thin-film layer form at least a portion of an optical filter.

### CROSS REFERENCE TO RELATED APPLICATIONS

Reference is made to commonly-assigned copending U.S. patent application Ser. No. 11/392,007, filed Mar. 29, 2006, entitled PROCESS FOR ATOMIC LAYER DEPOSITION, by David Levy; U.S. patent application Ser. No. 11/392,006, filed Mar. 29, 2006, entitled APPARATUS FOR ATOMIC LAYER DEPOSITION, by David Levy; U.S. patent application Ser. No. 11/861,539, filed Sep. 26, 2007, entitled THIN-FILM ENCAPSULATION CONTAINING ZINC OXIDE, by Fedorovskaya et al.; U.S. patent application Ser. No. 11/861,442, filed Sep. 26, 2007, entitled OLED DISPLAY ENCAPSULATION WITH THE OPTICAL PROPERTY, by Fedorovskaya et al.; U.S. patent application Ser. No. 11/620,744, filed Jan. 8, 2007, entitled DEPOSITION SYSTEM AND METHOD USING A DELIVERY HEAD SEPARATED FROM A SUBSTRATE BY GAS PRESSURE, by Levy; U.S. patent application Ser. No. 11/620,740, entitled DELIVERY DEVICE COMPRISING GAS DIFFUSER FOR THIN FILM DEPOSITION, by Nelson et al.; and U.S. patent application Ser. No. 11/620,738, filed Jan. 18, 2007, entitled DELIVERY DEVICE FOR DEPOSITION, by Levy; the disclosures of which are incorporated herein.

### FIELD OF THE INVENTION

This invention generally relates to thin-film electronic devices and components, such as electronic light-emitting displays, sensor arrays, and other electronic devices with environmental thin-film barrier layers and optical thin-film layers, wherein thin-film layers are made by vapor deposition and specifically, by atmospheric pressure atomic layer deposition process. In particular, the present invention relates to organic electronic light-emitting devices with protective thin-film material layers that function as optical coating layers and/or color filter layers, thus improving light output and lifetime.

### BACKGROUND OF THE INVENTION

Thin-film materials are utilized in a variety of applications. Examples include research and development and production applications, particularly in the fields of compound semiconductor, displays, LED, optical components, and ophthalmic devices. Thin-film materials are also used to create custom coatings and patterned substrates for sensors, flat-panel displays, micro-electro mechanical systems (MEMS), microcircuits, biomedical devices, optical instruments, microwave communications, integrated circuits, and microelectronics in general.

An optical coating is a thin layer of material placed on the device or optical component such as for example, a lens, a display, or a sensor, which changes the way light rays are reflected and transmitted. One type is the high-reflector coating used to produce mirrors which reflect greater than 99% of the incident light. Another type of optical coating is an antireflection coating, which reduces unwanted reflections from surfaces, and is commonly used on spectacle and photographic lenses. Multiple layer anti-reflection coatings, such as for example, a double layer anti-reflection coating consisting of SiN, or SiN and SiO2, can be used for high-efficiency solar cells, as described by Wright et al., Double Layer Anti-Reflective Coatings for Silicon Solor Cells, 2005 IEEE, pp. 1237-1240. This type of optical coating blocks the ultraviolet light while transmitting visible light.

Complex optical coatings exhibit high reflection over some range of wavelengths, and anti-reflection over another range, allowing the production of dichroic thin-film optical filters, such as described for example in U.S. Pat. No. 6,859,323 (Gasloli et al.).

An interference filter is an optical filter that reflects one or more spectral bands and transmits others, while maintaining a nearly zero coefficient of absorption for all wavelengths of interest. Such optical filters consist of multiple layers of coatings (usually dielectric or metallic layers) on a substrate, which have different refractive indices and whose spectral properties are the result of wavelength interference effects that take place between the incident and reflected light of different wavelengths at the thin-film boundaries.

Different layers of interference filters and other optical coatings have certain optical thickness to produce a filter with the desired characteristics, wherein the optical thickness for a transparent material is understood as its geometric thickness multiplied by the refractive index of the material, and is therefore synonymous with the optical path length. In constructing thin-film optical filters, multilayer thin-film coatings are often made with individual layers of optical thickness equal to one quarter of an appropriate wavelength of radiation, wherein each layer is presumed to have constant material composition throughout that layer.

As opposed to the above described conventional step-index multilayer filters, rugate filters are a class of optical filters that contain a continuous variation of the refractive index, usually sinusoidal, in the direction perpendicular to the plane of the filter as described, for example in B. E. Perilloux, Thin-film Design Modulated Thickness and Other Stopband Design Methods, SPIE Press, 2002. The reflectance of such a filter shows a high reflectivity “stop-band” around a characteristic wavelength and very low reflectivity elsewhere. These filters can be used, for example as single line stop-band filters, in various sensor applications. By combining several different sinusoidal refractive index distributions, rugate filters can be made to reproduce optical response functions, which are not possible using simple step-index profiles. However, such filters are difficult to fabricate because the continuous refractive index profile requires continuous variation in the density and/or composition of the filter material.

Interference filters can be used as color filters and in arrays, as color filter arrays to modify and control composition of reflected and transmitted light for displays, optical waveguides, optical switches, light sensors in the back of the cameras, etc. The advantage of color filters and color filter arrays made on the basis of thin-film interference filters is their high spectral selectivity, when the very high transmittance within, and very low transmittance outside, the passband of interest can be achieved. As a result, displays with such color filters can have a large gamut and produce very saturated colors. An example of a multilayer thin-film color filter is described in U.S. Pat. No. 5,999,321 (Bradley), which is incorporated herein by reference.

In electronic devices, color filters may be organized as color filter arrays (CFA). In sensors such as those used in cameras, the CFA is used in front of a panchromatic sensor to allow the detection of colored signals. The CFAs are usually an array of red, green, and blue areas laid down in a pattern. A common array used in digital cameras is the Bayer pattern array. The resolution of each color is reduced by as little as possible through the use of a 2×2 cell, and, of the three colors, green is the one chosen to be sensed twice in each cell as it is the one to which the eye is most sensitive.

Similar arrays can be used in displays, wherein the CFA is placed in register in front of white-light pixels to allow the viewing of color information. For example U.S. Pat. No. 4,877,697 (Vollmann et al.) describes arrays for liquid crystal displays (LCD) and U.S. Patent Application Publication No. 2007/0123133 (Winters) describes an array for an organic light-emitting diode (OLED) device.

The arrays can be made in many ways, including ink-jetting colored inks, using photolithography to pattern different colored materials in a desired fashion, etc. Color filter arrays can also be constructed as patterns of interference (or dichroic) filters. For example, U.S. Pat. No. 5,120,622 (Hanrahan) describes a method of using the photolithography technique, wherein two different photoresist material layers are deposited, exposed and developed to pattern the substrate for subsequent deposition of the dielectric layers, followed by removing unwanted material using a lift-off process.

A method of creating a dielectric interference filter system for an LCD display and a CCD array is described in the U.S. Pat. No. 6,342,970 (Sperger et al.). According to the method, different filter elements are prepared using substrate coating, masking via, for example, lithography process, plasma etching, and lift off techniques. A thin-film coating in the form of an interference filter can also be applied to a photovoltaic device to improve the efficiency with which a solar energy can be converted to electricity.

A photovoltaic device is a solid-state electrical device that converts light directly into direct-current electricity. The voltage-current characteristics of the device are a function of the characteristics of the light source, the materials used in the device and its design. Solar photovoltaic devices are made of various semi-conductor materials including inorganic materials such as silicon, cadmium sulfide, cadmium telluride, and gallium arsenide, in single crystalline, multi-crystalline, or amorphous forms, as well as organic materials consisting of crystalline or polycrystalline films of ‘small molecules’ (molecules of molecular weight of a few 100), amorphous films of small molecules, prepared by vacuum deposition or solution processing, films of conjugated polymers or oligomers processed from solution, and combinations of any of these either with other organic solids or with inorganic materials. A common example of organic material used in organic photovoltaics is polyphenylenevinylene (PPV) and its derivative methoxy-ethylhexyloxy-phenylenevinylene (MEH-PPV), as described in Yu, G., J. Gao, J. C. Hummelen, F. Wudl, and A. J. Heeger, 1995, Science 270(5243), 1789.)

As described, for example, in U.S. Patent Application Publication No. 2008/0000526 (Madigan), layers of optical material placed on top of the photovoltaic cell can be used as reflective filters to allow light of a desired range of wavelength to reach the photovoltaic cell and block or reduce light of other wavelength. This provides light with the spectral characteristics that better matches the conversion capabilities of the photovoltaic cell and consequently improves performance of the photovoltaic device.

In comparison with conventional, inorganic solar cells, organic photovoltaic devices have the potential to revolutionize the production of solar cells because of low cost and attractive attributes, such as lightweight, mechanical flexibility, possibility for mass production, their usage as wearable power sources, etc. However, challenges such as thermal and chemical instability, including degradation caused by reaction with environmental moisture and oxygen, as well as relatively low-power conversion efficiencies represent significant hurdles.

Organic light-emitting diodes (OLEDs) are a technology for flat-panel displays and area illumination lamps. The technology relies upon thin-film layers of organic materials coated upon a substrate. OLED devices generally can have two formats known as small-molecule devices such as disclosed in U.S. Pat. No. 4,476,292 (Ham et al.) and polymer OLED devices such as disclosed in U.S. Pat. No. 5,247,190 (Friend et al.). Either type of OLED device may include, in sequence, an anode, an organic EL element, and a cathode. The organic EL element disposed between the anode and the cathode commonly includes an organic hole-transporting layer (HTL), an emissive layer (EL) and an organic electron-transporting layer (ETL). Holes and electrons recombine and emit light in the EL layer. Tang et al. (Organic electroluminescent diodes, Applied Physics Letter, 51(12), 1987, pp. 913-915; Electroluminescence of doped organic thin films, Journal of Applied Physics, 65(9), 1989, pp. 3610-3616; and U.S. Pat. No. 4,769,292) demonstrated highly efficient OLEDs using such a layer structure. Since then, numerous OLEDs with alternative layer structures, including polymeric materials, have been disclosed and device performance has been improved. However, the materials comprising the organic EL element are sensitive and, in particular, are easily destroyed by moisture and high temperatures (for example, greater than 140 degrees C.).

Organic light-emitting diode (OLED) display devices typically require humidity levels below about 1000 parts per million (ppm) to prevent premature degradation of device performance within a specified operating and/or storage life of the device. Control of the environment to this range of humidity levels within a packaged device is typically achieved by encapsulating the device with an encapsulating layer and/or by sealing the device, and/or providing a desiccant within a cover. Desiccants such as, for example, metal oxides, alkaline earth metal oxides, sulfates, metal halides, and perchlorates are used to maintain the humidity level below the above-specified level. See, for example, U.S. Pat. No. 6,226,890 (Boroson et al.) describing desiccant materials for moisture-sensitive electronic devices. Such desiccating materials are typically located around the periphery of an OLED device or over the OLED device itself.

In alternative approaches, an OLED device is encapsulated using thin multilayer coatings of moisture-resistant material. For example, layers of inorganic materials such as metals or metal oxides separated by layers of an organic polymer may be used. Such coatings have been described in, for example, U.S. Pat. No. 6,268,695 (Affinito), U.S. Pat. No. 6,413,645 (Graff et al.), U.S. Pat. No. 6,522,067 (Graff et al.), and U.S. Patent Application Publication No. 2006/0246811 (Winters et al.), the latter reference hereby incorporated by reference in its entirety. Such encapsulating layers may be deposited by various techniques, including atomic layer deposition (ALD).

One such atomic layer deposition apparatus is further described in WO 01/082390 (Ghosh et al.) describes the use of first and second thin-film encapsulation layers made of different materials wherein one of the thin-film layers is deposited at 50 nm using atomic layer deposition discussed below. According to this disclosure, a separate protective layer is also employed, e.g., parylene. Such thin multi-layer coatings typically attempt to provide a moisture permeation rate of less than 5×10⁻⁶ g/m²/day to adequately protect the OLED materials. In contrast, typically polymeric materials have a moisture permeation rate of approximately 0.1 gm/m²/day and cannot adequately protect the OLED materials without additional moisture blocking layers. With the addition of inorganic moisture blocking layers, 0.01 g/m²/day may be achieved and it has been reported that the use of relatively thick polymer smoothing layers with inorganic layers may provide the needed protection. Thick inorganic layers, for example 5 microns or more of ITO or ZnSe, applied by conventional deposition techniques such as sputtering or vacuum evaporation may also provide adequate protection, but thinner conventionally coated layers may only provide protection of 0.01 gm/m²/day. U.S. Patent Application Publication No. 2007/0099356 (Park et al.) similarly describes a method for thin-film encapsulation of flat panel displays using atomic layer deposition.

WO 04/105149 (Carcia et al.) describes gas permeation barriers that can be deposited on plastic or glass substrates by atomic layer deposition. Atomic layer deposition is also known as atomic layer epitaxy (ALE) or atomic layer CVD (ALCVD), and reference to ALD herein is intended to refer to all such equivalent processes. The use of the ALD coatings can reduce permeation by many orders of magnitude at thicknesses of tens of nanometers with low concentrations of coating defects.

These thin coatings preserve the flexibility and transparency of the plastic substrate. Such articles are useful in container, electrical, and electronic applications. However, such protective layers also cause additional problems with light trapping in the layers since they may be of lower index than the light-emitting organic layers.

Although the requirement for the barrier layer of an OLED display has not been elucidated completely, Park et al., Ultrathin Film Encapsulation of an OLED by ALD, Electrochemical and Solid-State Letters, 8 (2), H21-H23, 2005, mentions that the barrier properties of water transmission rate less than 10⁻⁶ g/m²/day and oxygen transmission rate less than 10⁻⁵ cc/m²/day may be considered as sufficient.

In general, it has been found that multilayer combinations of specifically inorganic dielectrics layers and polymer layers can be more than three orders of magnitude less permeable to water and oxygen than an inorganic single layer, presumably due to the increased lag time of permeation (G. L. Graff et al., Mechanisms of vapor permeation through multilayer barrier films: Lag time versus equilibrium permeation, J. Appl. Physics, Vol. 96, No. 4, 2004, pp. 1840-1849). Barriers with alternating inorganic/organic layers with as many as 12 individual layers reportedly approach the performance needed by OLEDs (M. S. Weaver et al., Organic light-emitting devices with extended operating lifetimes on plastic substrates, Applied Physics Letter 81, No. 16, 2002, pp. 2929-2931). As a result, many existing thin-film encapsulation technologies focus on creating multilayers of thin-films, mostly, organic/inorganic combinations, though purely inorganic or organic encapsulations are also known. Where the inorganic material is involved, the deposition of a high barrier inorganic layer is considered to be the most important technology in the entire encapsulation process, since the permeation through the encapsulation layer is mostly controlled by the defects in inorganic film. While multiple layers provide better protection for OLED displays, thicker layers diminish transparency and as a result brightness and color saturation of the display.

Among the techniques widely used for producing thin-film layers is chemical vapor deposition (CVD). CVD uses chemically reactive molecules that react in a reaction chamber to deposit a desired film on a substrate. Molecular precursors useful for CVD applications comprise elemental (atomic) constituents of the film to be deposited and typically also include additional elements. CVD precursors are volatile molecules that are delivered, in a gaseous phase, to a chamber in order to react at the substrate, forming the thin-film thereon. The chemical reaction deposits a thin-film with a desired film thickness.

Common to most CVD techniques is the need for application of a well-controlled flux of one or more molecular precursors into the CVD reactor. A substrate is kept at a well-controlled temperature under controlled pressure conditions to promote chemical reaction between these molecular precursors, concurrent with efficient removal of byproducts. Obtaining optimum CVD performance requires the ability to achieve and sustain steady-state conditions of gas flow, temperature, and pressure throughout the process, and the ability to minimize or eliminate transients. Especially in the field of semiconductors, integrated circuits, and other electronic devices, there is a demand for thin-films, especially higher quality, denser films, with superior conformal coating properties, beyond the achievable limits of conventional CVD techniques, especially thin-films that can be manufactured at lower temperatures.

Atomic layer deposition (ALD) is an alternative film deposition technology that can provide improved thickness resolution and conformal capabilities, compared to its CVD predecessor. The ALD process segments the conventional thin-film deposition process of conventional CVD into single atomic-layer deposition steps. Advantageously, ALD steps are self-terminating and can deposit one atomic layer when conducted up to or beyond self-termination exposure times. An atomic layer typically ranges from about 0.1 to about 0.5 molecular monolayers, with typical dimensions on the order of no more than a few Angstroms. In ALD, deposition of an atomic layer is the outcome of a chemical reaction between a reactive molecular precursor and the substrate. In each separate ALD reaction-deposition step, the net reaction deposits the desired atomic layer and substantially eliminates “extra” atoms originally included in the molecular precursor. In its most pure form, ALD involves the adsorption and reaction of each of the precursors in the absence of the other precursor or precursors of the reaction. In practice, in any system it is difficult to avoid some direct reaction of the different precursors leading to a small amount of chemical vapor deposition reaction. The goal of any system claiming to perform ALD is to obtain device performance and attributes commensurate with an ALD system while recognizing that a small amount of CVD reaction can be tolerated.

In ALD applications, typically two molecular precursors are introduced into the ALD reactor in separate stages. For example, a metal precursor molecule, MLₓ, comprises a metal element, M that is bonded to an atomic or molecular ligand, L. For example, M could be, but would not be restricted to, Al, W, Ta, Si, Zn, etc. The metal precursor reacts with the substrate when the substrate surface is prepared to react directly with the molecular precursor. For example, the substrate surface typically is prepared to include hydrogen-containing ligands, AH or the like, that are reactive with the metal precursor. Sulfur (S), oxygen (O), and Nitrogen (N) are some typical A species. The gaseous metal precursor molecule effectively reacts with all of the ligands on the substrate surface, resulting in deposition of a single atomic layer of the metal:

substrate−AH+MLₓ→substrate−AMLₓ₋₁+HL (1)

where HL is a reaction by-product. During the reaction, the initial surface ligands, AH, are consumed, and the surface becomes covered with L ligands, which cannot further react with metal precursor MLₓ. Therefore, the reaction self-terminates when all of the initial AH ligands on the surface are replaced with AMLₓ₋₁ species. The reaction stage is typically followed by an inert-gas purge stage that eliminates the excess metal precursor from the chamber prior to the separate introduction of a second reactant gaseous precursor material.

The second molecular precursor then is used to restore the surface reactivity of the substrate towards the metal precursor. This is done, for example, by removing the L ligands and redepositing AH ligands. In this case, the second precursor typically comprises the desired (usually nonmetallic) element A (i.e., O, N, S), and hydrogen (i.e., H₂O, NH₃, H₂S). The next reaction is as follows:

substrate−A−ML+AH_{Y}→substrate−A−M−AH+HL (2)

This converts the surface back to its AH-covered state. (Here, for the sake of simplicity, the chemical reactions are not balanced.) The desired additional element, A, is incorporated into the film and the undesired ligands, L, are eliminated as volatile by-products. Once again, the reaction consumes the reactive sites (this time, the L terminated sites) and self-terminates when the reactive sites on the substrate are entirely depleted. The second molecular precursor then is removed from the deposition chamber by flowing inert purge-gas in a second purge stage.

In summary, then, the basic ALD process requires alternating, in sequence, the flux of chemicals to the substrate. The representative ALD process, as discussed above, is a cycle having four different operational stages:
1. MLₓ reaction;
2. MLₓ purge;
3. AH_{y} reaction; and
4. AH_{y} purge, and then back to stage 1.

This repeated sequence of alternating surface reactions and precursor-removal that restores the substrate surface to its initial reactive state, with intervening purge operations, is a typical ALD deposition cycle. A key feature of ALD operation is the restoration of the substrate to its initial surface chemistry condition. Using this repeated set of steps, a film can be layered onto the substrate in equal metered layers that are all identical in chemical kinetics, deposition per cycle, composition, and thickness.

ALD is particularly suited for forming thin layers of metal oxides in the components of electronic and optical devices. General classes of functional materials that can be deposited with ALD include conductors, dielectrics or insulators, and semiconductors.

However, ALD and CVD processes, as conventionally taught, are expensive and lengthy, requiring vacuum chambers and repeated cycles of filling a chamber with a gas and then removing the gas. Moreover, they usually employ heated substrates on which the materials are deposited. These heated substrates are typically at temperatures above the temperatures organic materials employed in OLED devices can tolerate. In addition, the films formed in such processes may be energetic and very brittle, such that the subsequent deposition of any materials over the films destroys the film's integrity.

One approach to overcome the inherent limitations of time depended ALD systems is to provide each reactant gas continuously and to move the substrate through each gas in succession. Such spatially dependent ALD systems are described in commonly-assigned U.S. patent application Ser. Nos. 11/392,007; 11/392,006; 11/620,744; and 11/620,740. All these identified applications are hereby incorporated by reference in their entirety. These systems attempt to overcome one of the difficult aspects of a spatial ALD system, which is undesired intermixing of the continuously flowing mutually reactive gases. In particular, U.S. Ser. No. 11/392,007 employs a novel transverse flow pattern to prevent intermixing, while U.S. Ser. No. 11/620,744 and U.S. Ser. No. 11/620,740 employ a coating head partially levitated by the pressure of the reactive gases of the process to accomplish improved gas separation. In addition, the deposition process described in the above mentioned U.S. patent applications is performed at atmospheric pressure, which involves orders of magnitude increase in the concentration of reactants, with consequent enhancement of surface reactant rates.

In view of the above, it can be seen that there is a need for developing processes and methods for producing electronic devices having thin-film material layers with designed barrier and optical properties.

### SUMMARY OF THE INVENTION

Briefly, according to one aspect, the present invention is directed towards an encapsulated electronic device, including a substrate; an electronic device on a first surface of the substrate; a first thin-film layer of a first inorganic material having a first optical property on the thin-film electronic device; and a second thin-film layer of a second inorganic material having a second optical property which is different from the first optical property on the first thin-film layer and wherein at least one of the first layer or the second layer is also an encapsulation layer and wherein the first thin-film layer and the second thin-film layer form at least a portion of an optical filter.

The invention and its objects and advantages will become more apparent in the detailed description of the preferred embodiment presented below.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a cross-sectional side view of a top-emitting OLED device according to an embodiment of the present invention;

FIG. 2 is a cross-section of an OLED device having color filters according to an alternative embodiment of the present invention;

FIG. 3 is a block diagram of the source materials for one embodiment of a method of thin-film deposition process employed in the Examples;

FIG. 4 is a cross-sectional side view of the a deposition device used in the present process, showing the arrangement of gaseous materials provided to a substrate that is subject to thin-film deposition process of the Examples; and

FIGS. 5a and 5b illustrate an encapsulating multilayer thin-film stack that is an optical filter produced using the deposition operation and its absorbance.

### DETAILED DESCRIPTION OF THE INVENTION

The present invention is directed to an electronic device, such as for example OLED, with thin-film material layers forming inorganic encapsulation layers and, at the same time, optical filter layers.

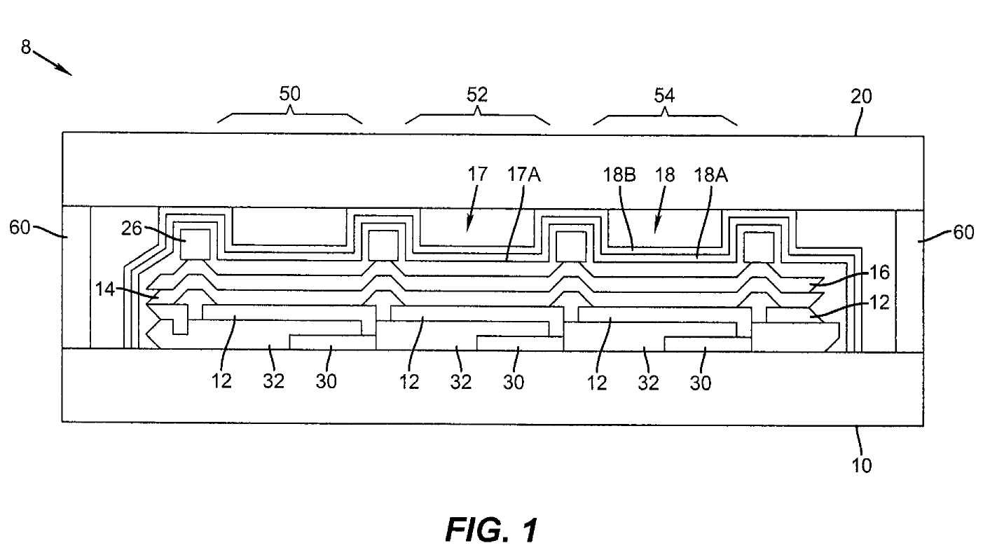

Referring to FIG. 1, an OLED device 8 according to one embodiment of the present invention comprises a substrate 10, a first electrode 12, a conductive electrode 16, an encapsulating thin-film package 17, comprising several layers, e.g. 17A and 18A, and an optical filter 18. The optical filter 18 comprises several layers, e.g. 18A and 18B, such that the encapsulating package and the optical filter have a common portion of layers, e.g. 18A. The OLED device 8 further includes one or more organic layers 14 formed between the first electrode 12 and the conductive electrode 16, at least one organic layer being a light-emitting layer.

In a top-emitter embodiment of an OLED device, the thin-film encapsulating package 17 is formed over a transparent top conductive electrode 16, and an optical filter 18 is formed to have an overlapping portion of layers with the encapsulating package, and the first electrode 12 is a bottom electrode. The bottom electrode may be reflective. It is preferred that the conductive electrode 16 has a refractive optical index equal to or greater than the refractive optical index of the one or more organic layers. By providing such relative refractive indices, light emitted from the organic layers 14 will not be trapped by total internal reflection in the organic layers 14 since light may travel from the organic layers 14 into the equal- or higher-index conductive electrode 16.

Thin-film electronic components 30 having planarization layers 32 can be employed to control the OLED device, as is known in the art. A cover 20 is provided over the OLED and electrode layers and adhered to the substrate 10 to protect the OLED device, for example using an adhesive 60.

The bottom first electrode 12 can be patterned to form light-emitting areas 50, 52, 54 while a patterned auxiliary electrode 26 may be formed between the light emitting areas (as shown) or under the light emitting areas (not shown). The conductive electrode 16 may be unpatterned and formed continuously over the organic layers 14.

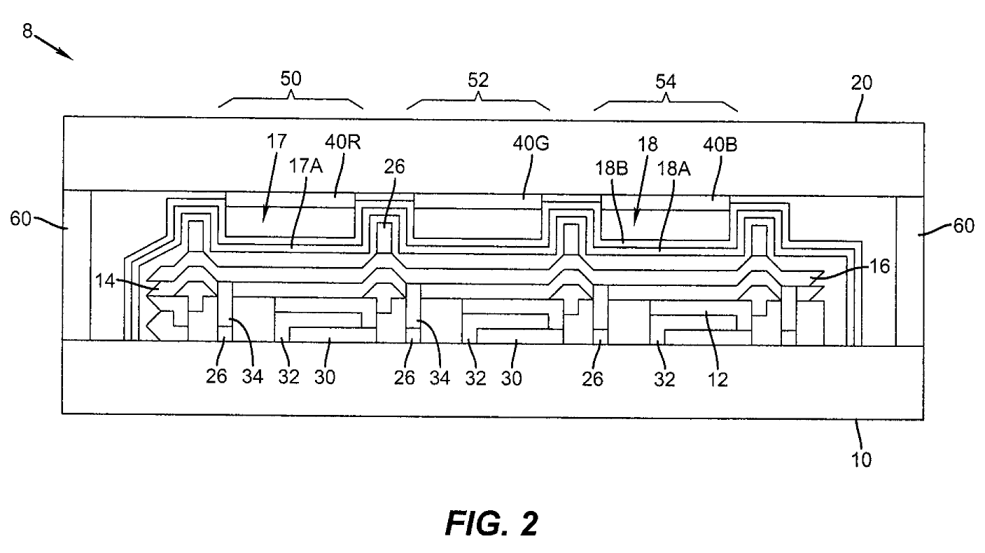

In some embodiments of the present invention (FIG. 2), the light-emitting organic layer 14 may emit white light, in which case color filters 40R, 40G, 40B may be formed, for example on the cover 20, to filter light to provide a full-color light-emissive device with colored light-emitting areas 50, 52, 54. In certain embodiments color filters 40R, 40G, and 40B may be formed as multilayer optical interference filters having layers common with the thin-film encapsulating package 17.

In various embodiments of the present invention, an auxiliary electrode 26 may be formed on the side of the conductive electrode 16 opposite the one or more organic layers, as shown in FIG. 2. Such layers may be deposited by sputtering or evaporating metals through masks, for example as described in U.S. Pat. No. 6,812,637 (Cok et al.). As shown in FIG. 2, the auxiliary electrode 26 may be formed on the side of the one or more organic layers 14 opposite the conductive electrode 16 and may be electrically connected to the conductive electrode 16 through vias 34 formed in the one or more organic layers 14. The auxiliary electrode may be formed using conventional photolithographic techniques while the vias may be formed using laser ablation, for example as described in U.S. Pat. No. 6,995,035 (Cok et al.). Materials employed in forming the auxiliary electrode may include, e.g., aluminum, silver, magnesium, and alloys thereof.

As employed herein, a thin-film encapsulating package 17 comprises one or more layers, e.g. 17A and 18A, preferably 2 to 15, depending on the thickness of each layer. Such layers can be applied to the OLED device by atomic layer or various chemical vapor deposition processes, thereby providing a thin-film encapsulating package 17 resistant to penetration by moisture and oxygen. Each layer of the thin-film encapsulating package 17 can be formed using an atomic layer deposition process, a vacuum chemical vapor deposition process, or atmospheric chemical vapor deposition process. These processes are similar in their use of complementary reactive gases, either in a system with a vacuum purge cycle or in an atmosphere. Generally, it is preferred to form the thin-film encapsulating package 17 at a temperature less than 140 degrees C. to avoid damaging organic layers. Alternatively, the thin-film encapsulating package 17 may be formed at a temperature less than 120 degrees C. or less than 110 degrees C. Furthermore, one or more layers of an encapsulating package consist of inorganic material, for example 18A, with a certain optical property and constitute a portion of an optical filter 18. The optical filter 18 comprises two or more layers, preferably 2 to 20 of thin-film material, for example, 18A and 18B, where one or more of the layers, for example 18B, have a second, different optical property, compared to other layers, for example the layer 18A.

A thin-film encapsulating package 17 has been successfully formed over organic materials using metal oxide compounds such as aluminum oxide and zinc oxide. Moreover, effective encapsulating layers have been formed at temperatures of 110 degrees C. Such temperatures are compatible with temperature-sensitive organic LED materials.

Each such encapsulating layer is formed by alternately providing a first reactive gaseous material and a second reactive gaseous material, wherein the first reactive gaseous material is capable of reacting with the organic layers treated with the second reactive gaseous material. The first reactive gaseous material completely covers the exposed surface of the OLED device, while the second reactive gaseous material reacts with the first reactive gaseous material to form a layer highly resistant to environmental contaminants. In contrast, layers deposited by conventional means such as evaporation or sputtering do not form hermetic layers. The conventional deposition art for encapsulating layers in protecting organic materials are problematic and improvements have been found by employing a thin-film encapsulating package 17 according to the present invention. Moreover, the preferred vapor deposition process of applying this encapsulating package reduces the potential damage incurred by the underlying organic layers in other processes.

A wide variety of metal oxides, nitrides, and other compounds may be employed to form the thin-film encapsulation package 17. For example, the thin-film encapsulation package 17 can comprise zinc oxide in combination with at least one other compound. The other compound can be a complex mixture created by applying dopants, for example by employing indium with tin oxide to form indium tin oxide.

A variety of thicknesses may be employed for the thin-film encapsulation package 17, depending on the subsequent processing of the device and environmental exposure. The thickness of the thin-film encapsulation package 17 may be selected by controlling the number of sequentially deposited layers of reactive gases.

A planarizing underlayer of parylene polymer can be used to improve the performance of a thin-film encapsulation package, as will be appreciated by the skilled artisan. Parylene layers for OLED encapsulation are disclosed in U.S. Patent Application Publication No. 2006/0246811 (Winters et al.), hereby incorporated by reference. For example, a polymeric layer of 120 nm parylene layer can be employed to achieve the planarizing effect and presumably to serve as a buffer layer for mitigating or augmenting stress force created by the inorganic encapsulate layers.

Referring again to the OLED device of FIG. 1, substrate 10 may be opaque to the light emitted by OLED device 8. Common materials for substrate 10 are glass or plastic. First electrode 12 may be reflective. Common materials for first electrode 12 are aluminum and silver or alloys of aluminum and silver or other metals or metal alloys. Organic layer 14 includes at least a light emitting layer (LEL) but frequently also includes other functional layers such as an electron transport layer (ETL), a hole transport layer (HTL), an electron blocking layer (EBL), or a hole blocking layer (HBL), etc. The discussion that follows is independent of the number of functioning layers and independent of the materials selection for the organic layer 14. Often a hole-injection layer is added between organic layer 14 and the anode and often an electron-injection layer is added between organic layer 14 and the cathode. In operation a positive electrical potential is applied to the anode and a negative potential is applied to the cathode. Electrons are injected from the cathode into organic layer 14 and driven by the applied electrical field to move toward the anode; holes are injected from the anode into organic layer 14 and driven by the applied electrical field to move toward the cathode. When electrons and holes combine in organic layer 14, light is generated and emitted by OLED device 8.

Material for the conductive electrode 16 can include inorganic oxides such as indium oxide, gallium oxide, zinc oxide, tin oxide, molybdenum oxide, vanadium oxide, antimony oxide, bismuth oxide, rhenium oxide, tantalum oxide, tungsten oxide, niobium oxide, or nickel oxide. These oxides are electrically conductive because of non-stoichiometry. The resistivity of these materials depends on the degree of non-stoichiometry and mobility. These properties as well as optical transparency can be controlled by changing deposition conditions. The range of achievable resistivity and optical transparency can be further extended by impurity doping. Even larger range of properties can be obtained by mixing two or more of these oxides. For example, mixtures of indium oxide and tin oxide, indium oxide and zinc oxide, zinc oxide and tin oxide, or cadmium oxide and tin oxide have been the most commonly used transparent conductors.

A top-emitting OLED device may be formed by providing a substrate 10 with a bottom first electrode 12 and one or more organic layers 14 formed thereon, at least one organic layer being a light-emitting layer, forming a conductive protective top conductive electrode 16 comprising a transparent conductive oxide over the one or more organic layers opposite the bottom first electrode 12 wherein the conductive electrode 16 is a layer having a thickness less than 100 nm, and forming a patterned auxiliary electrode 26 in electrical contact with the conductive electrode 16.

Alternatively, a bottom-emitting OLED device may be formed by providing a conductive protective bottom electrode comprising a transparent conductive oxide layer, as will be appreciated by the skilled artisan.

While prior-art atomic layer deposition processes may be employed to make the encapsulating package of the present invention, one embodiment of the method of making the present invention employs a moving gas distribution manifold or delivery head having a plurality of openings through which first and second reactive gases are pumped. The manifold is translated over a substrate to form a thin-film encapsulating package 17. Such a method is described in detail, the disclosures of which is hereby incorporated in its entirety by reference, in commonly-assigned copending U.S. patent application Ser. Nos. 11/392,007; 11/392,006; 11/620,738; 11/620,740; and 11/620,744. However, the present invention may be employed with any of a variety of prior-art vapor deposition methods, as stated above.

Thus, the encapsulation package may be applied to the OLED device by a deposition process employing a continuous (as opposed to pulsed) gaseous material distribution. Such a deposition process allows operation at atmospheric or near-atmospheric pressures as well as under vacuum and is capable of operating in an unsealed or open-air environment. Preferably, the deposition process proceeds at an internal pressure greater than 1/1000 atmosphere. More preferably, the transparent encapsulation package is formed at an internal pressure equal to or greater than one atmosphere.

In an ALD process, because each layer of the encapsulation package, can be deposited one monolayer at a time it tends to be conformal and have uniform thickness and will therefore tend to fill in all areas on the substrate, in particular in pinhole areas that may otherwise form shorts. The deposition of a variety of thin-films, including zinc oxide films over organic layers and electrodes has been successfully demonstrated. Various gaseous materials that may be reacted are also described in Handbook of Thin-film Process Technology, Vol. 1, edited by Glocker and Shah, Institute of Physics (IOP) Publishing, Philadelphia 1995, pages B1.5:1 to B1.5:16, hereby incorporated by reference; and Handbook of Thin-film Materials, edited by Nalwa, Vol. 1, pages 103 to 159, hereby incorporated by reference. In Table V1.5.1 of the former reference, reactants for various ALD processes are listed, including a first metal-containing precursors of Group II, III, IV, V, VI and others. In the latter reference, Table IV lists precursor combinations used in various ALD thin-film processes.

OLED devices of the present invention can also employ optical filters overlapping or combined with encapsulating packages to produce various well-known optical effects in order to enhance their properties if desired. This includes optimizing the encapsulation package to yield maximum light transmission providing anti-glare or anti-reflection coatings over the display, providing a polarizing medium over the display, or providing colored, neutral density, or color conversion filters over the display. Separate layers of coatings may be specifically provided in addition to the encapsulation package layers to form filters, polarizers, and anti-glare or anti-reflection films or included as a pre-designed characteristic of the encapsulation package, especially in the case of a multilayer encapsulation package. Such optical effects are further described in U.S. patent application Ser. No. 11/861,442, hereby incorporated by reference in its entirety.

The present invention may also be practiced with either active- or passive-matrix OLED devices. It can also be employed in display devices or in area illumination devices. In a preferred embodiment, the present invention is employed in a flat-panel OLED device composed of small-molecule or polymeric OLEDs as disclosed in, but not limited to, U.S. Pat. No. 4,769,292 (Tang et al.), and U.S. Pat. No. 5,061,569 (VanSlyke et al.). Many combinations and variations of organic light-emitting displays can be used to fabricate such a device, including both active- and passive-matrix OLED displays having either a top- or bottom-emitter architecture.

### EXAMPLES

### Description of the Coating Apparatus

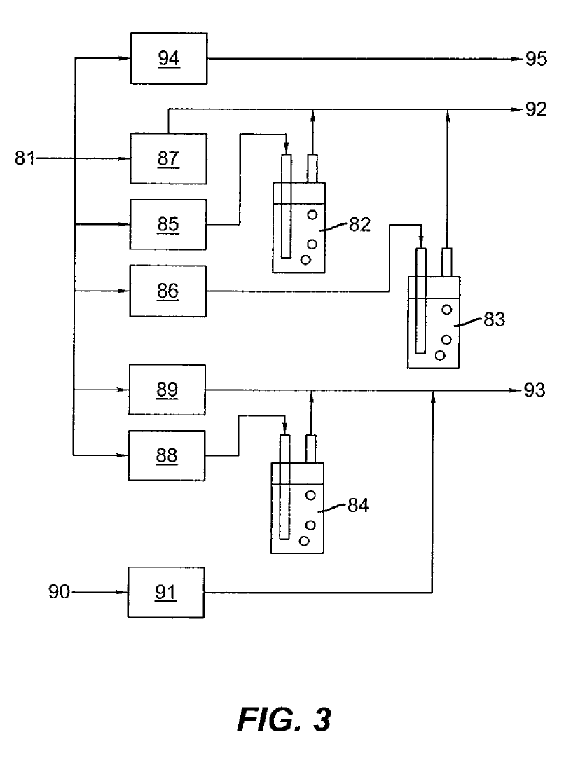

All of the following thin-film examples employ a coating apparatus for atomic layer deposition having the flow setup indicated in FIG. 3, which is a block diagram of the source materials for a thin-film deposition process.

The flow setup is supplied with nitrogen gas flow 81 that has been purified to remove oxygen and water contamination to below 1 ppm. The gas is diverted by a manifold to several flow meters which control flows of purge gases and of gases diverted through bubblers to select the reactive precursors. In addition to the nitrogen supply, air flow 90 is also delivered to the apparatus. The air is pretreated to remove moisture.

The following flows are delivered to the ALD coating apparatus: metal (zinc) precursor flow 92 containing metal precursors diluted in nitrogen gas; oxidizer-containing flow 93 containing non-metal precursors or oxidizers diluted in nitrogen gas; nitrogen purge flow 95 composed only of the inert gas. The composition and flows of these streams are controlled as described below.

Gas bubbler 82 contains diethylzinc. Gas bubbler 83 contains trimethylaluminum. Both bubblers are kept at room temperature. Flow meters 85 and 86 deliver flows of pure nitrogen to the diethylzinc bubbler 82 and trimethylaluminum bubbler 83, respectively. The flows of trimethylaluminum and diethylzinc can be alternately or sequentially supplied to the OLED device in order to provide alternating encapsulating layers on the OLED device or they can be supplied simultaneously for a mixed layer.

The output of the bubblers contains nitrogen gas saturated with the respective precursor solutions. These output flows are mixed with a nitrogen gas dilution flow delivered from flow meter 87 to yield the overall flow of metal precursor flow 92. In the following examples, the flows will be as follows:

| | |
|---|---|
| Flow meter 85: | To Diethylzinc Bubbler Flow |
| Flow meter 86: | To Trimethylaluminum Bubbler Flow |
| Flow meter 87: | To Metal Precursor Dilution Flow |

Gas bubbler 84 contains pure water for the control (or ammonia in water for the inventive example) at room temperature. Flow meter 88 delivers a flow of pure nitrogen gas to gas bubbler 84, the output of which represents a stream of saturated water vapor. An airflow is controlled by flow meter 91. The water bubbler output and air streams are mixed with dilution stream from flow meter 89 to produce the overall flow of oxidizer-containing flow 93 which has a variable water composition, ammonia composition, oxygen composition, and total flow. In the following examples, the flows will be as follows:

| | |
|---|---|
| Flow meter 88: | To Water Bubbler |
| Flow meter 89: | To Oxidizer Dilution Flow |
| Flow meter 91: | To Air Flow |

Flow meter 94 controls the flow of pure nitrogen that is to be delivered to the coating apparatus.

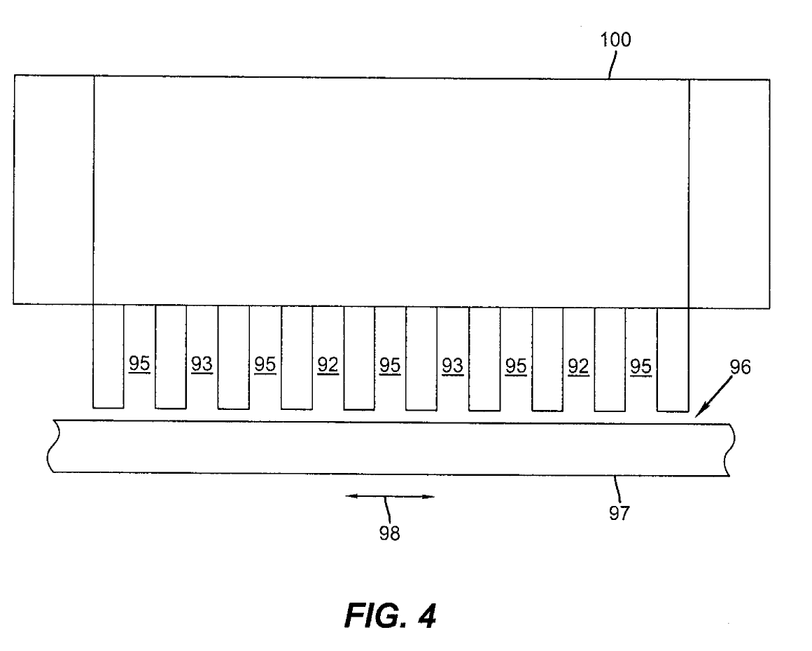

Streams or flows 92, 93, and 95 are then delivered to an atmospheric pressure coating head 100 where they are directed out of the channels or microchamber slots as indicated in FIG. 4. A gap 96 of approximately 0.15 mm exists between the elongated channels and the substrate 97. The microchambers are approximately 2.5 mm tall, 0.86 mm wide, and run the length of the coating head which is 76 mm. The reactant materials in this configuration are delivered to the middle of the slot and flow out of the front and back.

In order to perform a deposition, the coating head 100 is positioned over a portion of the substrate and then moved in a reciprocating fashion over the substrate, as represented by the arrow 98. The length of the reciprocation cycle was 32 mm. The rate of motion of the reciprocation cycle is 30 mm/sec.

### Description of OLED Test Conditions, Measurement and Analysis

The test conditions used to evaluate the OLED devices included:
1) Lighting them up by applying voltage to the cathode and anode.
2) Photographing lit up devices with the Sony XC-75 black and white CCD camera with the 3.72 μm/pixel resolution and 40× magnification. For the accurate dark spot evaluation the voltage was applied to the device to produce the best visual contrast for recognizing existence and measurements of the dark spots on the test icon.
3) Storing OLED devices either at the room temperature of 24° C., 50% relative humidity (RH) for certain period of time (some devices).
4) Storing the devices in the 85° C./85% (85/85) RH (humidity) chamber (HC) for accelerated humidity/oxygen resistance test.

### Materials Used:

(1) Me₃Al (commercially available from Aldrich Chemical Co.).

(2) Et₂Zn (commercially available from Aldrich Chemical Co.).

### Description of the Encapsulation Process Using the Coating Apparatus

An OLED device was constructed as detailed in Comparative Device 1. After the forming the cathode layer the OLED device was taken from a clean room and exposed to the atmosphere prior to depositing the thin-film encapsulating layer. The 2.5×2.5 inch square (62.5 mm square) OLED device was positioned on the platen of this device, held in place by a vacuum assist and heated to 110° C. The platen with the glass substrate was positioned under the coating head that directs the flow of the active precursor gasses. The spacing between the device and the coating head was adjusted to 30 microns by using a micrometer.

The coating head has isolated channels through which flow: (1) inert nitrogen gas; (2) a mixture of nitrogen, air and water vapor; (3) a mixture of active metal alkyl vapor (Me₃Al or Et₂Zn) in nitrogen. The flow rate of the active metal alkyl vapor was controlled by bubbling nitrogen through the pure liquid (Me₃Al or Et₂Zn) contained in an airtight bubbler by means of individual mass flow control meters. The flow of water vapor was controlled by adjusting the bubbling rate of nitrogen passed through pure water in a bubbler. The temperature of the coating head was maintained at 40° C. The coating process was initiated by oscillating the coating head across the substrate for the number of cycles specified.

In the following experiments, a flow rate of 26 sccm or 13 sccm was used to supply the diethylzinc. A flow rate of 4 sccm was used to supply the trimethylaluminum bubbler flow. A flow rate of 180 sccm or 150 sccm was used to supply the metal precursor dilution flow. A flow rate of 15 sccm was used to supply the water bubbler. A flow rate of 180 sccm or 150 sccm was used to supply the oxidizer dilution flow. A flow rate of 37.5 sccm or 31.3 sccm was used to supply the air flow.

The deposition process was calibrated to know the number of cycles to produce the desired thickness of zinc oxide or aluminum oxide layers. This number of cycles was then used to coat an OLED device with the encapsulation layer or layers, as desired. Immediately after encapsulation, the device was lit by applying voltage to the electrodes.

### Example 1

Various multilayers of Al₂O₃/ZnO stack, wherein the number and thickness of the layers were varied were made and tested. The multilayer stacks were about 2000 Å in total thickness.

The results showed that the multilayered film stacks consisting of Al₂O₃ and ZnO layers exhibited less or no cracks, meaning that the stress was better accommodated by the multilayer film stacks.

It was also shown that the multilayered Al₂O₃/ZnO film stacks can provide good protection: two of the inventive devices exhibited no dark spot growth in the center of the OLED pixels (edge growth can be eliminated by optimization of the geometry and the flow rates) after 24 and 48 hours of the humidity chamber. The coating for these two inventive devices comprised the following combination of layers:

| | |
|---|---|
| Al₂O₃ | 120 Å |
| ZnO | 100 Å |
| Al₂O₃ | 100 Å |
| ZnO | 150 Å |
| Al₂O₃ | 200 Å |
| ZnO | 200 Å |
| Al₂O₃ | 1000 Å |

### Example 2

An OLED device was coated with an encapsulation film containing a mixture of Al₂O₃/ZnO prepared by combining precursors for two oxides in the microchamber slots of a spatially dependent atomic layer deposition head, using water in another channel.

A total of 450 oscillation cycles were performed. During the coating process, first a 120 Å layer of pure Al₂O₃ was deposited. Then the flows of metal precursors to the trimethylaluminum bubbler flow and to the diethylzinc bubbler flow were gradually modified to increase a relative amount of ZnO and decrease the relative amount of Al₂O₃ until the film reached 100% of ZnO. Then the process was repeated in the opposite direction, diminishing the relative amount of ZnO while increasing the relative amount of Al₂O₃ such that the final 100 Å of material consisted of Al₂O₃ only. The total thickness of the mixed Al₂O₃/ZnO film was approximately 2000 Å.

After the coating process was completed, the voltage was applied to the electrodes and the dark spots were characterized. The device was then kept at 25 degrees C. and 50% RH for 7 days. During this period the device was repeatedly tested and demonstrated no or minimal growth of dark spots when lit. In comparison with the unencapsulated device kept in similar conditions, the mixed film of Al₂O₃ and ZnO provides significantly better protection against moisture and air.

The results showed that the film can be deposited crack-free or with fewer or smaller cracks. The mixed Al₂O₃/ZnO did not perform in the humidity chamber as well as the multilayer film stacks, supposedly because of the difficulty to control the composition in the current deposition system and elements of gas mixing, but the mixed Al₂O₃/ZnO film was still superior to the single Al₂O₃ or single ZnO film.

### Example 3

In this example, thin-film material coatings were carried out using an apparatus similar to that described above. Alumina and zinc oxide were coated. For alumina, a 1M solution of trimethylaluminum in heptane was in one bubbler and water in the other. For zinc oxide, diethylzinc 15 wt. % solution in hexane was in one bubbler and water was in the other bubbler.

For all oxides, the flow rate of the carrier gas through the bubblers was 50 ml/min. The flow rate of diluting carrier gas was 300 ml/min for the water reactant. The flow rate of the inert separator gas was 2 l/min. Nitrogen was used for the carrier gas in all instances. A calibration was run to determine the thickness versus number of substrate oscillations for the oxides. The substrate temperature was ˜220 degrees Celsius.

An encapsulating interference filter was created by depositing layers of zinc oxide and alumina interchangeably on a 62×62×1 mm glass slide using ALD system. The aim thicknesses of the layers were in order from the substrate up:

| | |
|---|---|
| Zinc oxide | 100 nm |
| Alumina | 100 nm |
| Zinc oxide | 100 nm |
| Alumina | 100 nm |
| Zinc oxide | 100 nm |
| Alumina | 200 nm |
| Zinc oxide | 100 nm |
| Alumina | 100 nm |
| Zinc oxide | 100 nm |
| Alumina | 100 nm |
| Zinc oxide | 100 nm |

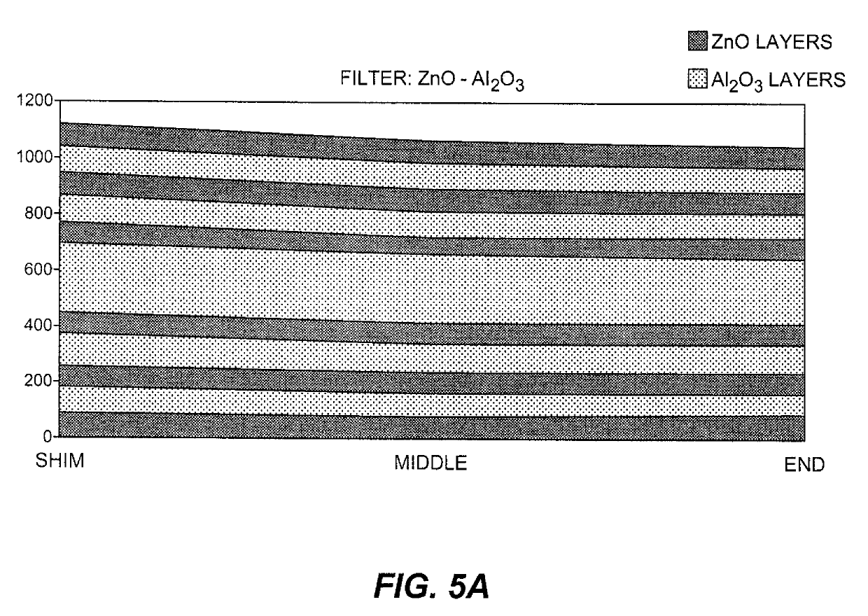

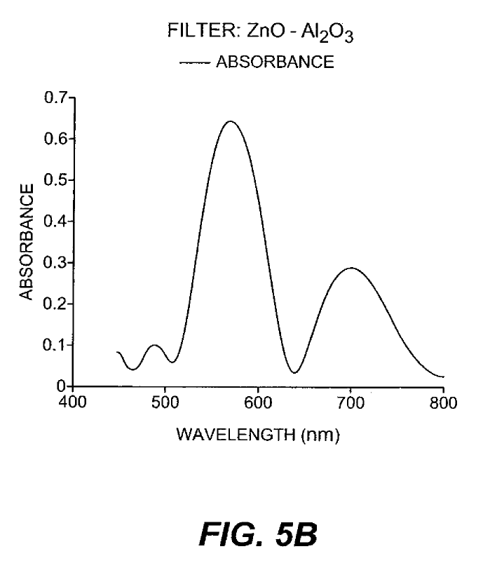

The diagram of the filter layers is shown in FIG. 5A. The absorbance of the filter was measured showing the peaks near 570 nm and around 700 nm, which is shown in FIG. 5B.

### Example 4

An encapsulating package with the interference filter was created by depositing layers of zinc oxide and alumina interchangeably on a bottom emitting OLED device using ALD system. The substrate temperature was kept at 110 degree C. The aim thicknesses of the layers were in order from the substrate up:

| | |
|---|---|
| Zinc oxide | 100 nm |
| Alumina | 100 nm |
| Zinc oxide | 100 nm |
| Alumina | 100 nm |
| Zinc oxide | 100 nm |
| Alumina | 200 nm |
| Zinc oxide | 100 nm |
| Alumina | 100 nm |
| Zinc oxide | 100 nm |
| Alumina | 100 nm |
| Zinc oxide | 100 nm |

The invention has been described in detail with reference to preferred embodiments thereof. It will be understood by those skilled in the art that variations and modifications can be effected within the scope of the invention.

### PARTS LIST

8 OLED device
10 substrate
12 first electrode
14 organic layer
16 conductive electrode
17 thin-film encapsulating package
17A thin-film encapsulating package layer
18 optical filter
18A optical filter layer
18B optical filter layer
20 cover
26 auxiliary electrode
30 thin-film electronic components
32 planarization layer
34 via
40R color filter
40G color filter
40B color filter
50 light-emitting area
52 light-emitting area
54 light-emitting area
60 adhesive
81 nitrogen gas flow
82 bubbler
83 bubbler
84 bubbler
85 flow meter
86 flow meter
87 flow meter
88 flow meter
89 flow meter
90 air flow
91 flow meter
92 metal (zinc) precursor flow
93 oxidizer-containing flow
94 flow meter
95 nitrogen purge flow
96 gap
97 substrate
98 arrow
100 coating head

1. An encapsulated electronic device comprising:
a) a substrate;
b) an electronic device on a first surface of the substrate;
c) a first thin-film layer of a first inorganic material having a first optical property on the thin-film electronic device; and
d) a second thin-film layer of a second inorganic material having a second optical property which is different from the first optical property on the first thin-film layer and wherein at least one of the first layer or the second layer is also an encapsulation layer and wherein the first thin-film layer and the second thin-film layer from at least a portion of an optical filter.

2. The encapsulated electronic device of claim 1 wherein the electronic device is a light-emitting device.

3. The encapsulated electronic device of claim 2 wherein the first and the second thin-film layers each have an optical thickness less than or equal to one half a wavelength of the emitted light.

4. The encapsulated electronic device of claim 1 wherein at least one of the first thin-film layer or the second thin-film layer is formed by atomic layer deposition or chemical vapor deposition.

5. The encapsulated electronic device of claim 2 wherein the light-emitting device is an organic light emitting device (OLED).

6. The encapsulated electronic device of claim 2 further comprising a first light emitting area having first and second thin-film layers with first optical thicknesses and a second light emitting area having first and second thin-film layers with second optical thicknesses wherein the first and second optical thicknesses are different.

7. The encapsulated electronic device of claim 1 further comprising a plurality of alternating thin-film layers of the first inorganic material and the second inorganic material.

8. The encapsulated electronic device of claim 1 further comprising a third thin-film layer of a third inorganic material.

9. The encapsulated electronic device of claim 1 further comprising a third thin-film layer of the first inorganic material having a third optical property.

10. The encapsulated electronic device of claim 9 wherein the third optical property is controlled by the deposition process parameters.

11. The encapsulated electronic device of claim 1 wherein the first material is ZnO.

12. The encapsulated electronic device of claim 11 wherein the second material is Al2O3.

13. The encapsulated electronic device of claim 1 wherein the electronic device is a photovoltaic device.

14. The encapsulated electronic device of claim 1 wherein first thin-film layer selectively reflects ambient ultraviolet light.

15. The encapsulated electronic device of claim 1 wherein the first thin-film layer has a gradient in refractive index.

16. The encapsulated electronic device of claim 15 wherein said first thin-film layer is a rugate filter.
